(19) United States
(12) Patent Application Publication
(10) Pub. No.: US 2007/0187356 A1
(43) Pub. Date: Aug. 16, 2007

(54) Method of manufacturing a resin molded article and the method of manufacturing an ink jet head

(75) Inventor: Koji Furukawa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/704,939

(22) Filed: Feb. 12, 2007

(30) Foreign Application Priority Data
Feb. 13, 2006 (JP) 2006-034897
Feb. 23, 2006 (JP) 2006-047098
Mar. 10, 2006 (JP) 2006-065877

(51) Int. Cl. G01D 15/00

(52) U.S. Cl. 216/27

(57) ABSTRACT

In the case of manufacturing resin-made parts by pressing against a heated resin material a heated die having concavo-convex patterns of inverse shapes with respect to the shapes of minute concave or convex portions of a resin molded article such as a head substrate of an ink jet head, at least one of temperatures of the die and the material, and resistance force received by the die from the material, and the die is pressed against the material while correcting press conditions based on a detected value. Alternatively, the parts are manufactured by releasing the cured material from the die by directly or indirectly pressing, with a press member through a through hole formed in the die, a surface of the material on a side in intimate contact with the die and in a region other than a region in which the concavo-convex patterns of the material are formed.

The entire contents of the document cited in this specification are herein incorporated by reference.

### BACKGROUND OF THE INVENTION

The present invention relates to a method of manufacturing a resin molded article having a structure in which a plurality of minute concave portions or convex portions are formed. More specifically, the present invention relates to a method of manufacturing a resin-made part which is produced by presswork and has a structure in which ink ejection ports are two-dimensionally arranged, and a method of manufacturing an ink jet head including the resin-made part manufactured by the resin-made part manufacturing method.

An electrostatic ink jet recording system of ejecting ink toward a recording medium by using electrostatic force has been known. The electrostatic ink jet recording system is a system of recording an image in accordance with image data on the recording medium in such a manner that ink containing charged particles is used, and a predetermined voltage (drive voltage) is applied to an ejection electrode (drive electrode) of an ink jet head in response to the image data, to thereby control the ejection of the ink by using electrostatic force.

As an example of an ink jet recording apparatus using the electrostatic ink jet recording system described above, JP 10-138493 A discloses an ink jet recording apparatus having such a structure that ink guides are provided in through holes serving as nozzles for ejecting the ink, and the ejection electrodes are arranged in the peripheries of the through holes. The disclosed ink jet recording apparatus applies a voltage in accordance with recorded data to the ejection electrodes, to thereby generate electric fields in the vicinities of the through holes, and exerts force derived from the electric fields on meniscuses of the ink, which are formed on tip ends of the ink guides, thereby ejecting ink droplets from the tip ends of the ink guides toward the recording medium. The ink jet heads according to the electrostatic ink jet method are capable of forming minute droplets with a simple structure. As a result, the ink jet heads described above have an advantage in that a multichannel structure having a plurality of ejection ports (channels) arranged in one head can easily be adopted.

### SUMMARY OF THE INVENTION

In an ink jet head having a structure in which ink guides are arranged in through holes serving as nozzles for ejecting ink, since the ink guides have a precise structure, a remarkable increase in cost is inevitable when the ink guides are manufactured by laser processing.

Further, in order to reduce a drawing time, it is necessary to achieve multichannels by arranging the ink guides two-dimensionally. As a method of realizing the multichannels, for example, it is considered to arrange the ink guides two-dimensionally by combining a plurality of parts in each of which the ink guides are arranged at given intervals in one direction. However, it is necessary for the ink guides to be arranged at given intervals with high precision. As a result, it is necessary to precisely combine the parts having the ink guides arranged at given intervals in one direction, so there arises a problem in that the cost is increased very much.

The present invention has been made in order to solve the above-mentioned problem. It is a first object of the present invention to provide a method of manufacturing a resin molded article, by which it is possible to manufacture, simply at low cost, a resin molded article having a structure in which a plurality of minute concave portions or convex portions are formed.

Further, it is a second object of the present invention to provide a method of manufacturing an ink jet head, by which it is possible to manufacture, simply at low cost, an ink jet head including a substrate in which minute ink guides are two-dimensionally arranged with high density and high precision.

In order to achieve the above-mentioned first object, a first aspect of the present invention provides a method of manufacturing a resin molded article having a structure in which concave portions or convex portions are minutely formed, the method comprising: a step of heating a resin material and a die having inverse shapes with respect to the shapes of the concave portions or the convex portions of the resin molded article; a step of pressing the heated die against the heated resin material while correcting press conditions; a step of detecting at least one of a temperature of the die, a temperature of the resin material, and resistance force received by the die from the resin material when the die is pressed against the resin material by a predetermined amount; and a step of correcting the press conditions based on a value detected in the step of detecting.

In this case, it is preferable that the press conditions include at least one selected from the group consisting of a press speed, a press load, the temperature of the die and the temperature of the resin material, and it is preferable that a ratio H/W be 2 or more to 50 or less, where H is a height of the convex portions or a depth of the concave portions, and W is a length of short sides of the convex portions or the concave portions.

Further, preferably, the resin molded article is a constituent part of an ink jet head including an ejection port substrate in which ejection ports for ejecting ink are formed, and is a substrate disposed oppositely to the ejection port substrate and including slim planar ink guides for guiding the ink individually to the ejection ports. It is preferable that the resin material be amorphous thermoplastic resin.

In order to achieve the above-mentioned second object, a second aspect of the present invention provides a method of manufacturing an ink jet head that ejects ink as droplets, including disposing an ejection port substrate, in which ejection ports for ejecting the ink are formed, on the substrate manufactured by the manufacturing method according to the first aspect of the present invention and including ink guides so that tip ends of the ink guides can be inserted into the ejection ports. Specifically, this aspect provides a method of manufacturing an ink jet head, comprising: a step of preparing, as constituent parts of the ink jet head that ejects ink as droplets, an ejection port substrate in which ejection ports for ejecting the ink are formed, and a head substrate disposed oppositely to the ejection port substrate and including slim planar ink guides for guiding the ink individually to the ejection ports; and a step of disposing the ejection port substrate oppositely to the head substrate so that tip ends of the ink guides of the head substrate can be inserted into the ejection ports of the ejection port substrate, wherein the step of preparing the head substrate comprises: a step of heating a resin material and a die having inverse shapes with respect to the shapes of the ink guides of the head substrate; a step of pressing the heated die against the heated resin material while correcting press conditions; a step of detecting at least one of a temperature of the die, a temperature of the resin material, and resistance force received by the die from the resin material when the die is pressed against the resin material by a predetermined amount; and a step of correcting the press conditions based on a value detected in the step of detecting.

In order to achieve the above-mentioned first object, a third aspect of the present invention provides a method of manufacturing a resin molded article having a structure in which concave portions or convex portions are minutely formed, the method comprising: a step of heating a resin material and a die having inverse shapes with respect to the shapes of the concave portions or the convex portions of the resin molded article; a step of pressing the heated die against the heated resin material; a step of cooling and curing the resin material; and a step of releasing the cured resin material from the die by directly or indirectly pressing, with a press member through a through hole formed in the die, a surface of the resin material on a side in intimate contact with the die and in a region other than a region in which the concave portions or convex portions are formed.

In this case, preferably, the step of pressing includes a step of pressing the die against the resin material in a state where a release plate having a given thickness is interposed in the region of the surface of the resin material other than the region where the concave portions or convex portions are formed, and the step of releasing is a step of releasing the resin material by pushing the release plate by the press member. Preferably, the release plate is fixed to the press member.

In addition, preferably, the method of manufacturing resin molded article further comprises: a steps of detecting at least one of a temperature of the die, a temperature of the resin material, and resistance force received by the die from the resin material when the die is pressed against the resin material; and a steps of correcting the press conditions based on a value detected in the step of detecting. In this case, preferably, the press conditions include at least one selected from the group consisting of a press speed, a press load, the temperature of the die and the temperature of the resin material.

Further, it is preferable that a ratio H/W be 2 or more to 50 or less, where H is a height of the convex portions or a depth of the concave portions, and W is a thickness of the convex portions or a length of the concave portions in a direction perpendicular to a longitudinal direction (in a short-lateral direction).

Further, preferably, the resin molded article is a constituent part of an ink jet head including an ejection port substrate in which ejection ports for ejecting ink are formed, and is a substrate disposed oppositely to the ejection port substrate and including slim planar ink guides for guiding the ink individually to the ejection ports. It is preferable that the resin material be amorphous thermoplastic resin.

In order to achieve the above-mentioned second object, a fourth aspect of the present invention provides a method of manufacturing an ink jet head that ejects ink as droplets, the method including: disposing an ejection port substrate, in which ejection ports for ejecting the ink are formed, on the substrate manufactured by the manufacturing method according to the third aspect of the present invention and including ink guides so that tip ends of the ink guides can be inserted into the ejection ports. Specifically, this aspect provides a method of manufacturing an ink jet head, comprising: a step of preparing, as constituent parts of the ink jet head that ejects ink as droplets, an ejection port substrate in which ejection ports for ejecting the ink are formed, and a head substrate disposed oppositely to the ejection port substrate and including slim planar ink guides for guiding the ink individually to the ejection ports; and a step of disposing the ejection port substrate oppositely to the head substrate so that tip ends of the ink guides of the head substrate can be inserted into the ejection ports of the ejection port substrate, wherein the step of preparing the head substrate comprises: a step of heating a resin material and a die having inverse shapes with respect to the shapes of the ink guides of the head substrate; a step of pressing the heated die against the heated resin material; a step of cooling and curing the resin material; and a step of releasing the cured resin material from the die by directly or indirectly pressing, with a press member through a through hole formed in the die, a surface of the resin material on a side in intimate contact with the die and in a region other than a region in which the ink guides of the head substrate are formed.

According to the method of manufacturing a resin molded article of the first aspect of the present invention, a resin molded article in which the plurality of minute concave portions or convex portions are formed with high density and high precision can be manufactured simply at low cost. In particular, even in the case of a resin molded article in which minute concave portions or convex portions in micron order with a ratio (aspect ratio) of a depth or a height to a width being 5 or more are two-dimensionally arranged with high density, such a resin molded article can be manufactured simply at low cost.

Further, according to the method of manufacturing an ink jet head of the second aspect of the present invention, an ink jet head including a resin-made substrate in which the ink guides are two-dimensionally arranged with high density and high precision can be manufactured simply at low cost.

According to the method of manufacturing a resin molded article of the third aspect of the present invention, the resin molded article in which the plurality of minute concave portions or convex portions are formed with high density and high precision can be easily detached from the die without deforming the concave portions or convex portions. In particular, even in the case of the resin molded article in which the minute concave portions or convex portions in micron order with a ratio (aspect ratio) of a depth or a height to a width being 5 or more are two-dimensionally arranged with high density, the resin molded article can be manufactured simply at low cost without deforming the minute concave portions or convex portions with such a high aspect ratio.

Further, according to the method of manufacturing an ink jet head of the fourth aspect of the present invention, the ink jet head including the resin-made substrate in which the ink guides are two-dimensionally arranged with high density and high precision can be manufactured simply at low cost in volume. Consequently, the method according to the fourth aspect of the present invention is optimum as a method of manufacturing the electrostatic ink jet head.

Further, the ink jet head obtained by the present invention is manufactured by the method of manufacturing an ink jet head according to the second or fourth aspect of the present invention. Accordingly, even if the ink jet head has a minute structure in which ink guides for forming meniscuses of the ink are arranged with high precision and high density in the ejection ports for ejecting the ink, the ink jet head can be manufactured at low cost. Consequently, according to the ink jet head obtained by the present invention, a cost reduction in high-definition and high-quality image recording can be realized.

### BRIEF DESCRIPTION OF THE DRAWINGS

In the accompanying drawings:

FIG. 1A is a cross-sectional view schematically showing a configuration of one embodiment of an ink jet head obtained by the method of the present invention;

FIG. 1B is a cross-sectional view taken along line B-B of FIG. 1A;

FIG. 2 is a cross-sectional view taken along line II-II of FIG. 1A;

FIG. 3 is a schematic perspective view showing a head substrate of the ink jet head shown in FIG. 1A, ink guides being formed on the head substrate;

FIG. 4A is a schematic plan view of the head substrate shown in FIG. 3;

FIG. 4B is a cross-sectional view taken along line B-B of FIG. 4A;

FIG. 4C is a cross-sectional view taken along line C-C of FIG. 4A;

FIGS. 5A to 5C are a schematic perspective view, a schematic front view, and a schematic side view of the ink guide shown in FIG. 3, respectively;

FIGS. 6A to 6C are a schematic perspective view, a schematic front view, and a schematic side view of an ink guide which is different from the ink guide shown in FIGS. 5A to 5C, respectively;

FIG. 7 is a view schematically showing a planar structure of a shield electrode formed in an ejection port substrate of the ink jet head shown in FIG. 1A;

FIGS. 8A to 8C are schematic views for illustrating an example of manufacturing processes for the head substrate shown in FIG. 3;

FIGS. 9A to 9H are schematic views for illustrating another example of the manufacturing processes for the head substrate shown in FIG. 3;

FIG. 10 is a schematic perspective view of an embodiment of a release jig in which a release plate is fixed to leg portions to integrate the leg portions and the release plate, the release jig being used in the manufacturing processes for the head substrate shown in FIGS. 9A to 9H; and

FIG. 11 is a schematic perspective view of another embodiment of the release jig that directly presses a surface of a resin substrate, the release jig being used in the manufacturing processes for the head substrate shown in FIGS. 9A to 9H.

### DETAILED DESCRIPTION OF THE PREFERRED EMBODIMENTS

Now a detailed description will be made of a method of manufacturing a resin molded article and a method of manufacturing an ink jet head according to the present invention, based on preferred embodiments illustrated in the accompanying drawings.

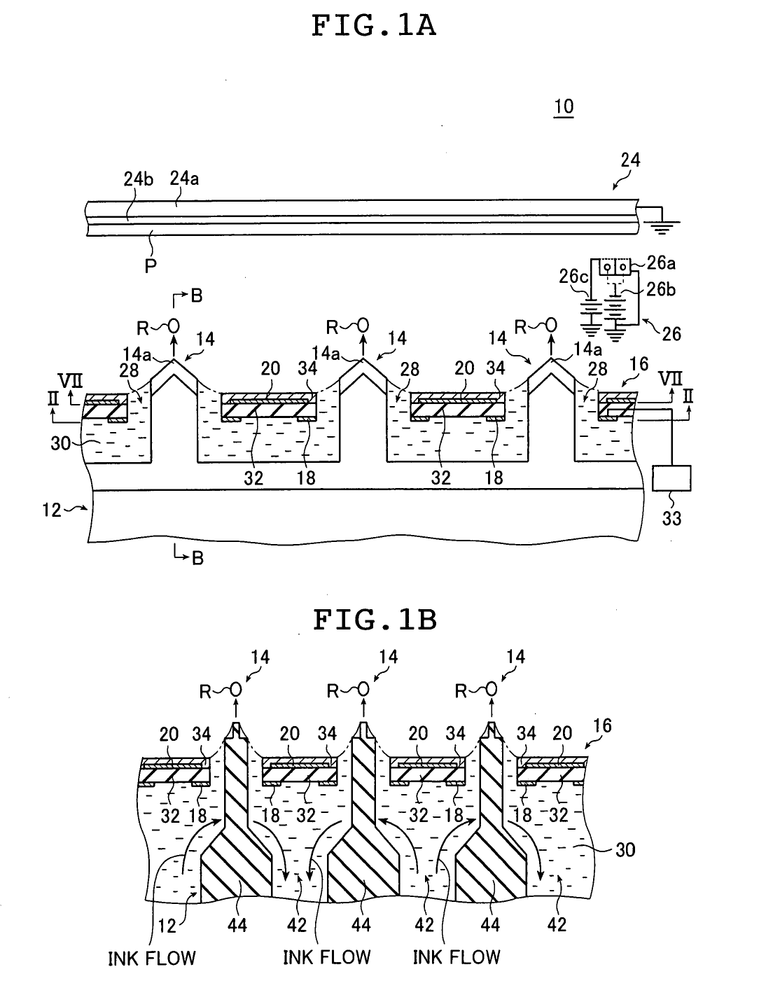

In the embodiments described below, a description will be made of a head substrate of an ink jet head having a structure shown in FIGS. 1A and 1B, as a representative example of the resin molded article manufactured by the method of the present invention. In this connection, in combination with the head substrate, a description will also be made of the method of manufacturing an ink jet head, and of the ink jet head obtained thereby. Note that the method of manufacturing a resin molded article according to the present invention is not limited to this, and for example, can also be applied to a method of manufacturing a resin molded article such as a substrate of a DNA chip for use in a molecular diagnosis in a medical field as described in JP 11-187900 A and JP 11-510681 A.

The configuration of the ink jet head shown in FIGS. 1A and 1B will be explained.

FIG. 1A is a cross-sectional view schematically showing a configuration of one embodiment of the ink jet head, and FIG. 1B is a cross-sectional view taken along line B-B in FIG. 1A.

As shown in FIG. 1A, an ink jet head 10 comprises a resin-made head substrate 12 in which ink guides 14 are formed, and an ejection port substrate 16 in which a plurality of ejection ports 28 are formed. Ejection electrodes 18 are disposed on the ejection port substrate 16 so as to surround the respective ejection ports 28. At a position facing the surface (i.e., upper surface in FIG. 1A) of the ink jet head 10 on the ink ejection side, a counter electrode 24 supporting a recording medium P is disposed.

The head substrate 12 and the ejection port substrate 16 are arranged so that they face each other with a predetermined distance therebetween. By a space formed between the head substrate 12 and the ejection port substrate 16, an ink flow path 30 for supplying ink to each ejection port 28 is formed. In the ink jet head 10 in this embodiment, the ink Q flows in a vertical direction in the ink flow path 30 as indicated by arrows in FIG. 1B (i.e., in a direction perpendicular to the paper surface of FIG. 1A).

In FIGS. 1A and 1B, for easy-to-understand illustration of the configuration of the ink jet head 10, only three of the multiple ejection ports which are adjacent to one another are shown.

In the ink jet head 10 of this embodiment, for example, the ink Q is used in which fine particles containing colorant such as pigment, and having electrical charges (hereinafter referred to as the “colorant particles”) are dispersed in an insulative liquid (carrier liquid). Also, an electric field is generated between the ejection port 28 and the ink guide 14, and the counter electrode 24 through application of a drive voltage to the ejection electrodes 18 provided in the ejection port substrate 16, and the ink aggregated at the ink guide 14 in the ejection port 28 is ejected by means of electrostatic force. Further, by turning ON/OFF the drive voltage applied to the ejection electrode 18 in accordance with image data (ejection ON/OFF), ink droplets are ejected from the ejection port 28 in accordance with the image data and an image is recorded on the recording medium P.

In order to perform image recording at a higher density and at high speed, the ink jet head 10 has a multichannel structure in which multiple ejection ports 28 are arranged in a two-dimensional manner.

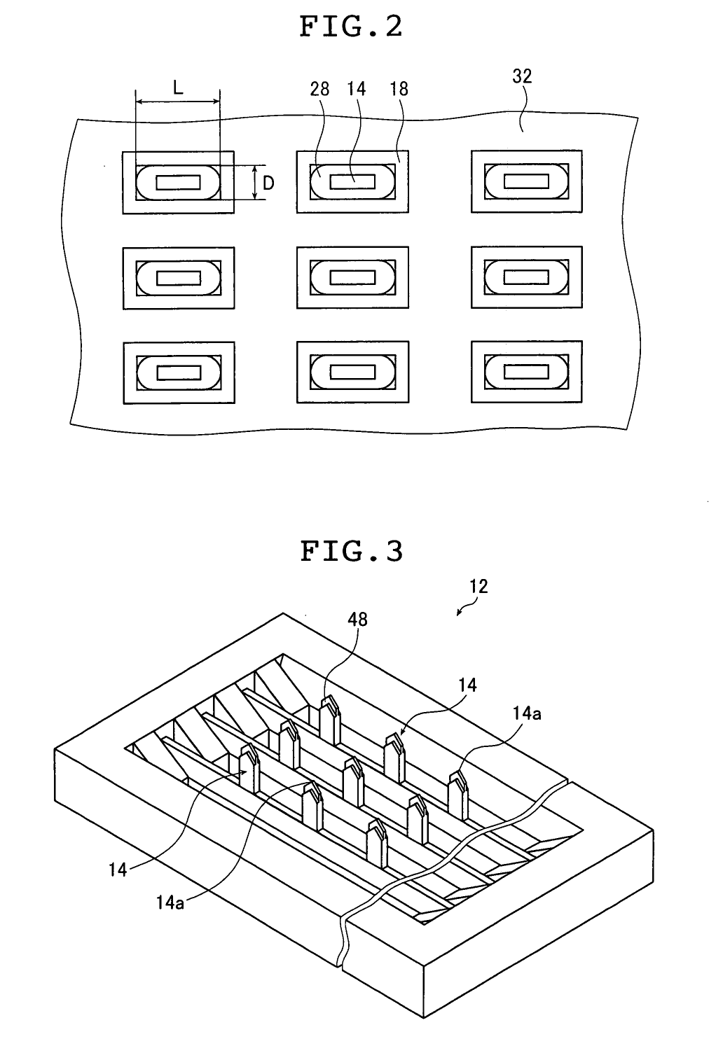

FIG. 2 is a cross-sectional view taken along line II-II in FIG. 1A, and partially and schematically shows a state in which multiple ejection ports are two-dimensionally formed in the ink jet head 10.

In the ink jet head 10 of this embodiment, it is possible to freely choose the number of the ejection ports 28, the physical arrangement position thereof and the like. For example, the structure may be the multichannel structure shown in FIG. 2 in which the ejection ports 28 are arranged in a matrix manner or a structure having only one line of the ejection ports. The ink jet head 10 may be a so-called (full-)line head having lines of ejection ports corresponding to the whole area of the recording medium P or a so-called serial head (i.e., shuttle type head) which performs scanning in a direction perpendicular to the nozzle line direction. The ink jet head manufactured by the method of the present invention can cope with both of a monochrome recording apparatus and a color recording apparatus.

In the ink jet head 10 of this embodiment, the ejection ports 28 are arranged so that the arrangement interval between adjacent ejection ports 28 is 2 mm or less. Note that the arrangement interval between adjacent ejection ports 28 is the distance between the centers of the adjacent ejection ports 28.

The arrangement interval between adjacent ejection ports 28 is 2 mm or less, so that the ejection ports 28 are arranged at high density. Thus, the ink jet head 10 can be compact, which makes it possible to increase the number of head parts produced in one process. Further, it becomes possible to reduce the amount of materials required for producing one head, which makes it possible to reduce the production cost. Consequently, the ink jet head 10 can be produced at a lower cost.

The configuration of the ink jet head 10 shown in FIGS. 1A, 1B, and 2 will be explained in more detail.

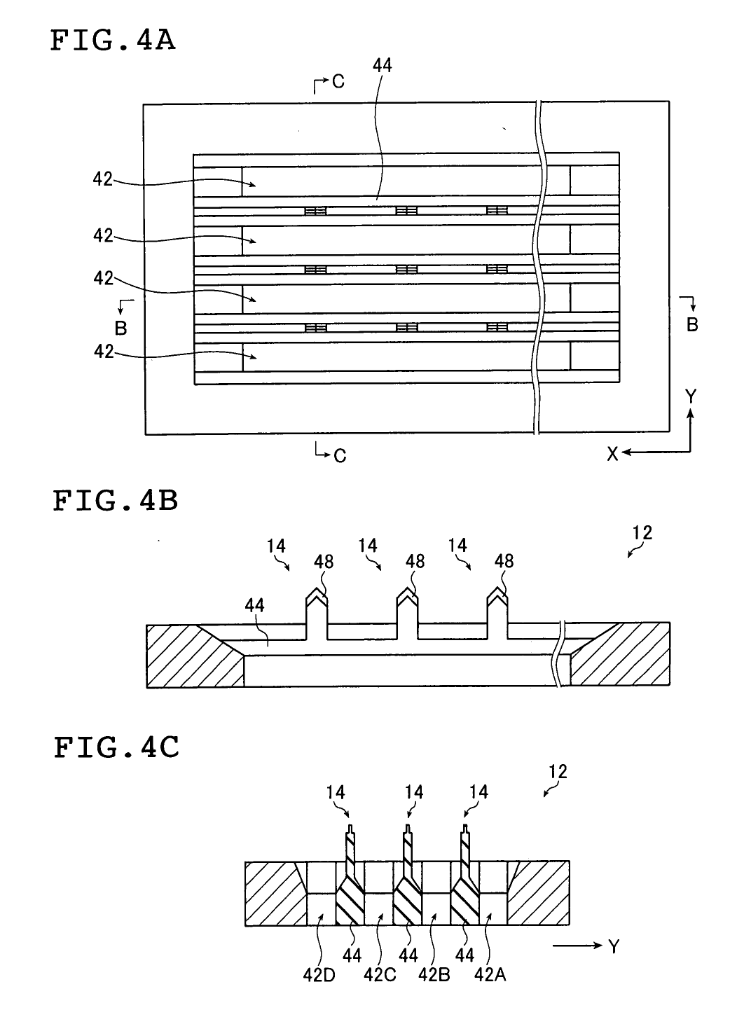

First, the head substrate 12 is explained. FIG. 3 shows a schematic perspective view of the head substrate 12. FIG. 4A shows a schematic plan view of the head substrate 12. FIGS. 4B and 4C show cross-sectional views taken along lines B-B and C-C in FIG. 4A, respectively.

The head substrate 12 is a resin substrate having a rectangular outline. As shown in FIG. 4A, four elongated rectangular shaped openings 42 are formed in the middle of the head substrate 12. Each opening 42 is formed to extend in a longitudinal direction of the head substrate 12 (i.e., direction shown by X in FIG. 4A), and penetrates the head substrate 12 in the thickness direction thereof. Three guide bases 44 are formed each between adjacent openings 42, and they extend in parallel with each other in the longitudinal direction of the head substrate 12. A plurality of minute ink guides 14 are formed at constant intervals on the upper surface of each guide base 44. The number of the guide bases 44 is determined corresponding to the number of lines of the ejection ports 28 in the ejection substrate 16.

The lower part of the head substrate 12 having a structure shown in FIGS. 3 to 4B is connected to a not shown ink supply source. In the ink jet head including the head substrate 12, the ink is supplied to the ejection ports 28 in the ejection substrate 16 through the openings 42. That is, as shown in FIGS. 1A and 1B, the ink flow path 30 is formed by the space formed between the head substrate 12 and the ejection port substrate 16, and the openings 42 formed in the head substrate 12. In the head substrate 12 shown in FIG. 4C, the ink is supplied from downward to upward in the openings 42A and 42C. The supplied ink passes over the upper portions of the guide bases 44 so as to get around the ink jet heads 14. Thereafter, the ink is flown into the adjacent openings 42B and 42D to be recovered from the lower sides thereof. In this manner, the ink is circulated between the not shown ink supply source and the ejection ports 28 of the ejection port substrate 16.

As shown in FIG. 1B, the ink flows in a vertical direction of the openings 42 in the head substrate 12 to be supplied to the ejection ports 28 in the ejection port substrate 16, however, the ink may be supplied to the ejection ports 28 by causing the ink to flow in a direction parallel to the direction in which the guide base 44 extends. Each opening 42 may not penetrate the head substrate 12, and may have finite depth so that the bottom surface thereof is formed on the head substrate 12. In this case, connection holes may be provided in the lower surface or side surface of the head substrate so that the openings 42 are connected to the ink supply source, and the ink is caused to flow into the openings 42 through the connection holes to be supplied to the ejection ports 28.

Four openings 42 are formed in the head substrate 12, and three guide bases 44 are provided corresponding to the number of the lines of the ejection ports 28 in the ejection port substrate 16, however, the present invention is not limited thereto. For example, when the number of the lines of the ejection ports 28 is one, only one guide base may be provided, and when the number of the lines of the ejection ports 28 is two, two guide bases may be provided. When the number of the lines of the ejection ports 28 is four or more, four or more guide bases 44 may be provided at the intervals corresponding to the intervals of the lines of the ejection ports 28.

As shown in FIG. 3 and FIGS. 4A to 4C, the ink guides 14 are provided on the upper surface of each guide base 44. In this embodiment, the ink guides 14 are integrally formed on each guide base 44. In this embodiment, when the ink jet head 10 is assembled by combining the head substrate 12 and the ejection port substrate 16, each ink guide 14 has a predetermined height so that it extends through the ejection port 28 formed in the ejection port substrate 16, and the tip end portion 14a thereof projects above the surface of the ejection port substrate 16 on the recording medium P side. Each ink guide 14 is capable of guiding the ink to the tip end portion 14a thereof and stabilizing the meniscus of the ink at the ejection port 28 in the ejection port substrate 16.

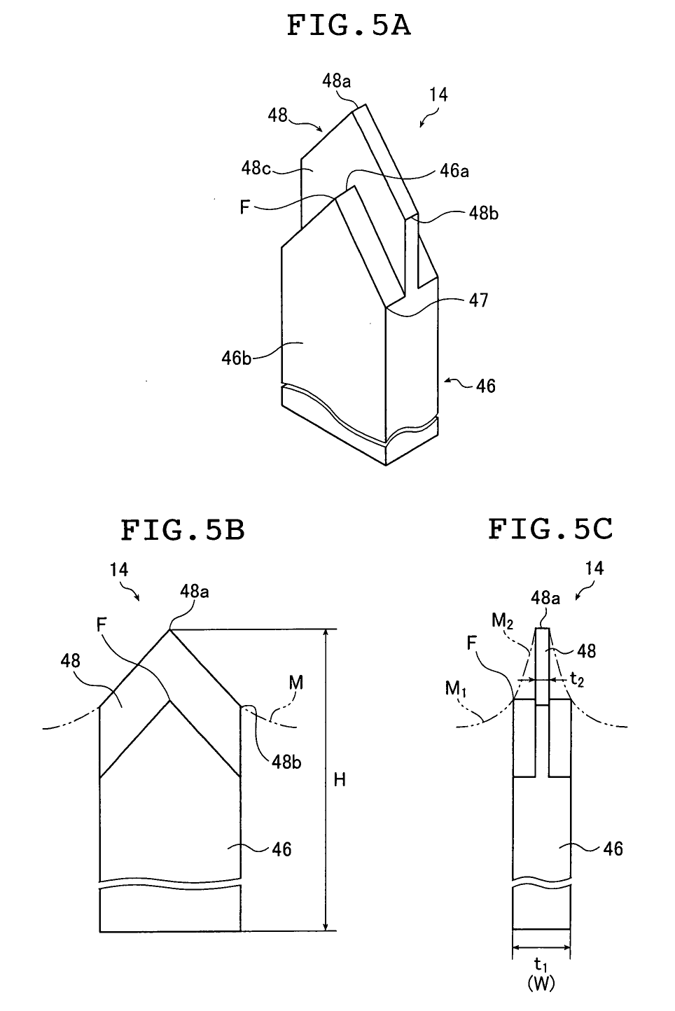

FIGS. 5A to 5C each shows a schematic perspective view of the ink guide 14. The ink guide 14 in this embodiment includes a plate shaped main body 46 with a wide width in a direction in which the guide base 44 extends, and a projecting piece 48 integrally formed on the tip end portion of the main body 46. The projecting piece 48 is thinner than the main body 46, and the tip end thereof is sharp. The projecting piece 48 is formed at the position approximately in the middle of the main body 46 in the thickness direction. As viewed in a plan view, the tip end portion of the main body 46 has approximately a triangular shape with a tip end 46a as a vertex. Similarly to the tip end portion of the main body 46, as viewed in a plan view, the projecting piece 48 also has approximately a triangular shape with a tip end 48a as a vertex. The angle of the tip end 46a of the main body 46 and the angle of the tip end 48a of the projecting piece 48 are not specifically limited, however, in order to improve the responsivity and approximate the shape of the tip ends of the main body 46 and the projecting piece 48 to a meniscus shape, in other words, in order to approximate the shape of the tip ends of the main body 46 and the projecting piece 48 to a meniscus shape for improving the responsivity, they are preferably 60° to 100°.

In the illustrated example, the tip end 48a of the projecting piece 48 is formed sharp, however, it may be formed to have a curved shape as viewed in a plan view and/or in a side view.

There is no specific limit to the thickness of the ink guide 14, however, the thickness t1 of the main body 46 is preferably 30 μm to 100 μm in order to arrange the ink guides 14 in high density while maintaining the strength thereof. The thickness t2 of the projecting piece 48 is preferably 10 μm to 20 μm in order to concentrate the electric field while maintaining the strength thereof.

In this embodiment, the aspect ratio (H/t1) is preferably 2 or more, and more preferably 5 or more in order to form the ink flow path 30 while the ink guides penetrates the ejection port substrate. In the aspect ratio, ti is the thickness (i.e., length in the short-lateral direction) of the main body 46 of the ink guide 14, and H is the height (i.e., distance from the upper surface of the head substrate to the tip end of the ink guide) of the ink guide 14. The upper limit of the aspect ratio is 50, because the ink guide having a structure in which the aspect ratio is more than 50 is difficult to produce even by the manufacturing method of the present invention.

Further, in the present invention, the short side length of the convex portion or concave portion formed in the resin molded article is defined as W. In the case where the short side length of the convex portion or concave portion does not change in the direction of the height H of the convex portion or the depth H of the concave portion, it can be used as the short side length W as it is. However, in the case where the short side length of the convex portion or the concave portion changes in the direction of the height H of the convex portion or the depth H of the concave portion, the characteristic dimension, i.e., the most dominant dimension, of the short side of the convex portion or the concave portion in the direction of the height H or the depth H may be used as the short side length W.

Accordingly, in this embodiment, the thickness (i.e., length in the short-lateral direction, that is, length in the direction vertical to the direction in which the head substrate extends) of the ink guide 14 corresponding to the convex portion which is formed in the head substrate 12 corresponding to the resin molded article is defined as W. However, the thickness of the ink guide 14 changes in the direction of the height H of the ink guide 14. The thickness t1 of the main body 46 of the ink guide 14 can be adopted as the characteristic dimension, i.e., the most dominant dimension, of the thickness of the ink guide 14. Thus, the thickness t1 of the main body 46 of the ink guide 14 is regarded as the thickness W of the ink guide 14, so the relation between the thickness W of the ink guide 14 and the height H of the ink guide 14, i.e., the aspect ratio H/W, is preferably 2≦H/W≦50, more preferably, 5≦H/W≦50.

A meniscus of the ink formed by the ink guide having the shape as shown in FIGS. 5A to 5C will be explained. FIGS. 5A to 5C are a schematic perspective view, a schematic front view, and a schematic side view, of the ink guide 14, respectively.

In the ink guide 14 shown in FIGS. 5A to 5C, the tip end 46a of the main body 46 functions as a pinning point (i.e., fixing point) F of a meniscus M. The position of the pinning point F is determined based on the shape of the tip end 46a of the main body 46 and is a stable point that will not move once fixed. Further, the pinning point F also functions as a pinning point that fixes a new meniscus M2 formed along the projecting piece 48. Therefore, the ink reaches the tip end 48a of the projecting piece 48. The ink guide 14 of such structure allows the meniscus M2 of the ink to be formed at a higher position in comparison with the ink guide composed only of the main body 46 without having the projecting piece 48.

In the present invention, when the ink jet head is constituted by combining the head substrate 12 and the ejection port substrate 16, the ink guide 14 is preferably formed to have a height so that the tip end 46a of the main body 46 of the ink guide 14 projects from the surface of the ejection port substrate 16. With this structure, the position of the meniscus M2 of the ink formed along the projecting piece 48 of the ink guide 14 can be higher than the surface of the ejection port substrate 16.

In the length direction (i.e., height direction) of the ink guide 14, the ink guide 14 is preferably formed such that the position of the tip end 46a of the main body 46 of the ink guide 14 is above the position of shoulder portions 48b of the projecting part 48 (i.e., end portions of the projecting part 48 in the width direction). Therefore, it becomes possible to make the ink stably reach the tip end of the projecting piece 48 of the ink guide 14, and make the meniscus of the ink closer to the counter electrode 24 (refer to FIG. 1A).

The shape of the ink guide 14 formed in the head substrate 12 has been explained above, however, the shape of the ink guide is not limited to the above one. In the ink guide 14 shown in FIGS. 5A to 5C, the projecting piece 48 is formed at the position approximately in the middle of the main body 46 in the thickness direction, however, the ink guide 14 may be configured such that the projecting piece 48 is moved in the thickness direction so that a side surface 46b of the main body 46 and a side surface 48c of the projecting piece 48 on the same side flush with each other.

In the present invention, a metal film may be formed onto the tip end portion of the projecting piece 48 or the main body 46 of the ink guide 14 by evaporation. The formation of such metal film on the projecting piece or the main body of the ink guide allows the dielectric constant to be substantially increased. As a result, a strong electric field is generated with ease at the ejection port when a voltage is applied to the ejection electrode, which makes it possible to improve ejection property of the ink.

A slit serving as an ink guide groove that gathers the ink Q to the tip end portion 14a by means of a capillary phenomenon may be formed in a center portion of the ink guide 14 in a vertical direction in FIG. 5B.

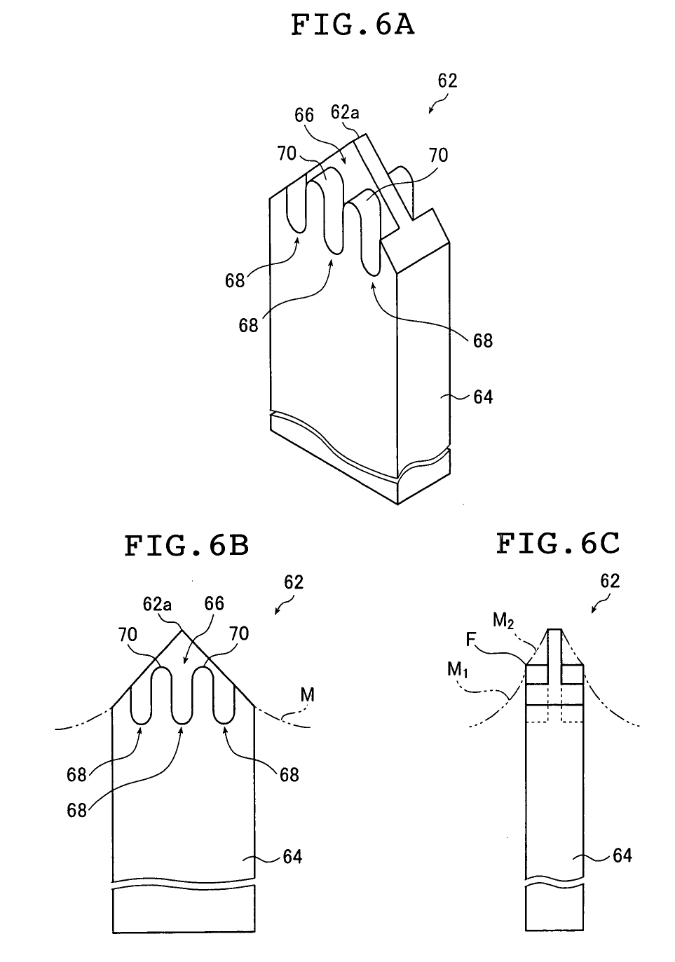

Another example of the structure of the ink guide formed in the head substrate 12 is shown in FIGS. 6A to 6C.

FIGS. 6A to 6C are a schematic perspective view, a schematic front view, and a schematic side view, of an ink guide 62, respectively.

In the ink guide 62, comb portions 66 are formed on both of the side surfaces (i.e., front and back side surfaces in FIG. 6A) of the tapered tip end portion of the main body 64. Each comb portion 66 includes three cutouts 68 and two teeth 70 formed between the cutouts 68. In this manner, there are formed three cutouts (vertical grooves) 68 that extend downwardly while being in parallel with each other and are spaced apart from each other at constant intervals in the width direction in each of the both side surfaces of the tip end portions of the ink guide 62. The three cutouts 68 are formed, so that two teeth 70 are formed therebetween. The tip ends (i.e., upper ends) of the teeth 70 are each formed by a curved surface.

The comb portions 66 are formed on both side surfaces in the thickness direction of a tip end portion 62a of the ink guide 62, so that the cutouts 68 of the comb portions 66 play a role of an ink reservoir and a role of capillaries. Accordingly, it becomes possible to stably supply the ink to the tip end portion of the ink guide 62. In order to stably supply the ink to the tip end portion of the ink guide, it is preferable that a distance between the upper ends of the teeth 70 and the upper end of the ink guide 62 be short.

Each upper end of the teeth 70 functions as a meniscus pinning point, like the tip end of the main body 46 of the ink guide 14 shown in FIGS. 5A to 5C. Therefore, it is preferable that the upper ends of the teeth 70 exist on the upper side with respect to the surface of the ejection port substrate 16.

It should be noted that the ink guide 62 has the three cutouts 68 on each of the both side surfaces of the tip end portion 62a, but the present invention is not limited to this, and at least one cutout 68 will suffice.

Next, a meniscus formed by the ink guide having the shape shown in FIGS. 6A to 6C is described.

In the ink guide having the shape shown in FIGS. 6A to 6C, each edge of the upper ends of the teeth 70 of each comb portion 66 in the width direction functions as a pinning point F of a meniscus M1. The pinning point F is determined based on the shape of the comb portion 66 and is a stable point that will not move once fixed. Further, the pinning point F also functions as a pinning point that fixes a new meniscus M2 formed along the tip end portion 62a of the ink guide 62. Therefore, it becomes possible to make the ink reach the tip end of the tip end portion 62a.

In the ink guide 62 shown in FIGS. 6A to 6C, since the comb portions 66 are formed on the side surfaces in the thickness direction, even if the ink liquid surface is lower than the position of the upper ends of the teeth 70 of the comb portions 66, the ink reserved in the cutouts 68 of the comb portions 66 is supplied to the upper ends of the teeth 70 of the comb portions 66 by means of a capillary phenomenon. Also, the ink supplied to the teeth 70 is further supplied to the tip end portion 62a of the ink guide 62, so that a meniscus of the ink can be formed at the tip end portion of the ink guide 62. The ink guide 62 with such shape is excellent in shape stability of a meniscus formed at the tip end portion, so even when disturbances such as vibrations are given, fluctuations of the shape of the meniscus of the ink formed at the tip end portion of the ink guide can be suppressed.

In the ink jet head including the ink guide 62 having such shape, the position of a meniscus of the ink at the opening is further raised above the surface of the ejection port substrate, and the ink is sufficiently supplied to the tip end of the ink guide. Therefore, the ejection responsivity of the ink droplets at the time of ejection is high, and the adhering position accuracy of the ink droplets is also high. In addition, it becomes possible to reduce variations in size of the ink droplets, specially, when color images are formed, it becomes possible to prevent or suppress color drift. Whereby, high definition and high quality image can be obtained.

The comb portion is formed on each of the both side surfaces of the tip end of the ink guide in this embodiment, but may be formed only on one side surface.

Another example of the structure of the ink guide has been explained above. However, the shape of the ink guide is not limited to the above shape, and the ink guide may consist only of the main body 46 without providing the projecting part 48.

The ink guide of the above example is formed to have a flat plate shape with a wide width in the direction in which the head substrate extends, however, the present invention is not limited to this, and the ink guide may have a rectangular cylindrical shape or a circular cylindrical shape. The head substrate including the ink guide of such various shapes can be produced with ease by using a later described nanoimprint method.

Next, the ejection port substrate 16 of the ink jet head 10 is explained referring to FIGS. 1A and 1B.

As shown in FIG. 1A, the ejection port substrate 16 of the ink jet head 10 comprises an insulating substrate 32, a shield electrode 20, the ejection electrodes 18, and an insulating layer 34. On a surface on an upper side in FIG. 1A (i.e., surface opposite to a side facing the head substrate 12) of the insulating substrate 32, the shield electrode 20 and the insulating layer 34 are laminated in order. Also, for a surface on a lower side in FIG. 1A (i.e., surface on the side opposing the head substrate 12) of the insulating substrate 32, the ejection electrodes 18 are formed.

As shown in FIG. 2, each ejection port 28 is an elongated cocoon-shaped (i.e., oval) opening (i.e., slit) which is obtained by connecting a semicircle to each short side of a rectangle. Also, the ejection port 28 has an aspect ratio (L/D) between the length L in the direction in which the guide base of the head substrate arranged facing the ejection port substrate extends and the length D in the direction perpendicular to the guide base extending direction of 1 or more.

In the present invention, the ejection port 28 whose aspect ratio (L/D) between the length L in the direction in which the guide base of the head substrate extends and the length D in the direction perpendicular to the guide base extending direction is 1 or more (an anisotropic shape with its long sides extending in the guide base extending direction) is formed as an opening, so that ink becomes easy to flow to the ejection port 28. That is, the capability of supplying ink particles to the ejection port 28 is enhanced, which makes it possible to improve the frequency responsivity and also prevent clogging. This point will be described later in detail together with the ink droplet ejection action.

In this embodiment, the ejection port 28 is formed as the elongated cocoon-shaped opening, however, the present invention is not limited to this and it is possible to form the ejection port 28 in another arbitrary shape, such as an approximately circular shape, an oval shape, a rectangular shape, a rhomboid shape, or a parallelogram shape, so long as it is possible to eject ink from the ejection port 28 and the aspect ratio between the length in the guide base extending direction and the length in the direction perpendicular to the guide base extending direction is 1 or more. For instance, the ejection port may be formed in a rectangular shape whose long sides extend in the ink flow direction, or an oval shape or a rhomboid shape whose major axis extends in the ink flow direction.

As shown in FIG. 2, the ejection electrodes 18 are formed on the lower surface (i.e., surface facing the head substrate 12) of the ejection port substrate 16. The ejection electrodes 18 each has a rectangular frame like (square) shape, and is disposed along the rim of the cocoon-shaped ejection port 28 so as to surround the periphery of the ejection port 28. That is, the ejection electrode 18 has a rectangular frame like shape with its opening formed in a rectangular shape. In FIG. 2, the ejection electrode 18 is formed in a rectangular frame like shape, however, it is possible to change the shape of the ejection electrode 18 to various other shapes so long as the ejection electrode is disposed to face the ink guide. For example, the ejection electrode 18 may be a cocoon-shaped electrode similarly to the shape of the ejection port, a ring shaped circular electrode, an oval electrode, a divided circular electrode, a parallel electrode, a substantially parallel electrode, a channel shaped electrode in which one side of a rectangular frame is removed, or the like, corresponding to the shape of the ejection port 28.

As described above, the ink jet head 10 has a multichannel structure in which multiple ejection ports 28 are arranged in a two-dimensional manner. Therefore, as schematically shown in FIG. 2, the ejection electrodes 18 are respectively disposed for the ejection ports 28 in a two-dimensional manner.

The ejection electrodes 18 are exposed to the ink flow path 30 and in contact with the ink Q flowing in the ink flow path 30. Thus, it becomes possible to significantly improve ejection property of ink droplets. This point will be described in detail later together with an action of ejection.

As shown in FIG. 1A, each ejection electrode 18 is connected to a control unit 33. The control unit 33 is capable of controlling a voltage value and a pulse width of the drive voltage applied to the ejection electrode 18 at the time of ejection and non-ejection of the ink.

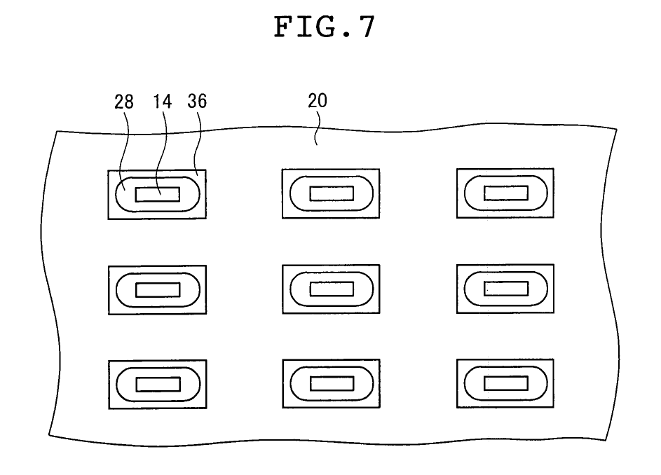

The shield electrode 20 is formed on the surface of the insulating substrate 32 and the surface of the shield electrode 20 is covered with the insulating layer 34. In FIG. 7, a planar structure of the shield electrode 20 is schematically shown. FIG. 7 is a cross-sectional view taken along line VII-VII in FIG. 1A and schematically shows the planar structure of the shield electrode 20 of the ink jet head having the multichannel structure. As shown in FIG. 7, the shield electrode 20 is a sheet-shaped electrode, such as a metallic plate, which is common to each ejection electrode and has openings 36 at positions corresponding to the ejection electrodes 18 respectively formed on the peripheries of the ejection ports 28 arranged in a two-dimensional manner. Each opening 36 of the shield electrode 20 is formed in a rectangular shape so that it has a length and a width exceeding the length and the width of the ejection port 28.

It is possible for the shield electrode 20 to suppress electric field interference by shielding against electric lines of force between adjacent ejection electrodes 18, and a predetermined voltage (including 0 v when grounded) is applied to the shield electrode 20. In the illustrated embodiment, the shield electrode 20 is grounded and hence has 0 V as the applied voltage.

As a preferred embodiment, as shown in FIG. 1A, the shield electrode 20 is formed in the layer different from that containing the ejection electrodes 18, and moreover, its whole surface is covered with the insulating layer 34.

The ink jet head 10 has the insulating layer 34, whereby the electric field interference between adjacent ejection electrodes 18 can be suitably prevented. Moreover, discharging between the ejection electrode 18 and the shield electrode 20 can also be prevented even when the colorant particles of the ink Q are formed into a coating.

The shield electrode 20 needs to be provided so as to block the electric lines of force of the ejection electrodes 18 provided on other ejection ports 28 (hereinafter referred to as “other channels”) and the electric lines of force directed to the other channels while ensuring the electric lines of force acting on the corresponding ejection port 28 (hereinafter referred to as “own channel” for convenience) among the electric lines of force generated from the ejection electrodes 18.

In the case of the ink jet head with no shield electrode 20 provided therein, at the time of ejection of ink droplets, electric lines of force generated from the end portion on an ejection port side of the ejection electrode 18 (hereinafter referred to as the “inner edge portion of the ejection electrode”) converge inside the ejection electrode 18, that is, in an area surrounded by the inner edge portion of the ejection electrode 18, act on the own channel, and generate an electric field necessary for the ink droplet ejection. On the other hand, electric lines of force generated from the end portion on a side opposite to the ejection port side of the ejection electrode 18 (hereinafter referred to as the “outer edge portion of the ejection electrode”) may diverge further outside from the outer edge portion of the ejection electrode 18, exert influence on other channels, and cause electric field interference.

If the above points are taken into consideration, the width and the length of the rectangular opening 36 of the shield electrode 20, when the substrate plane is viewed from above, is preferably made larger than the width and the length defined by the inner edge portion of the ejection electrode 18 of the own channel to avoid shielding against the electric lines of force directed to the own channel. Specifically, the end portion of the shield electrode 20 on the ejection port 28 side is preferably more spaced apart (retracted) from the ejection port 28 than the inner edge portion of the ejection electrode 18 of the own channel.

In addition, for the efficient shielding against the electric lines of force directed to the other channels, the length and the width of the rectangular opening 36 of the shield electrode 20, when the substrate plane is viewed from above, is preferably made smaller than the length and the width defined by the outer edge portion of the ejection electrode 18 of the own channel. Specifically, the inner edge portion of the shield electrode 20 is preferably closer (advanced) to the ejection port 28 than the outer edge portion of the ejection electrode 18 of the own channel. According to the studies made by the inventor of the present invention, the distance between the outer edge portion of the ejection electrode 18 and the end portion of the shield electrode 20 is preferably equal to or larger than 5 μm, more preferably equal to or larger than 10 μm.

With the above configuration, while ensuring the stable ejection of the ink droplets from the ejection port 28, for example, variations in the ink adhering position due to the electric field interference between the adjacent channels can be suitably suppressed, thus a high-quality image can be consistently recorded.

The shield electrode 20 may be provided (that is, the opening 36 of the shield electrode 20 may be formed) so that the shape of the opening 36 of the shield electrode 20 is made substantially similar to the shape formed by the inner edge portion or the outer edge portion of the ejection electrode 18, and the inner edge portion of the shield electrode 20 is more spaced apart (retracted) from the ejection port 28 than the inner edge portion of the ejection electrode 18 of the own channel and is closer (advanced) to the ejection port 28 than the outer edge portion of the ejection electrode 18.

In the above example, the shield electrode 20 is made as a sheet-shaped electrode, however, the present invention is not limited to this and the shield electrode 20 may have any other shapes or structures so long as it is possible to shield the respective ejection ports against electric lines of force of other channels. For instance, the shield electrode 20 may be provided between respective ejection ports in a mesh shape. Also, when the intervals between the adjacent ejection ports in the row direction and the intervals between the adjacent ejection ports in the column direction are different from each other in the matrix of the multiple ejection ports, for instance, a construction may be used in which the shield electrode is not provided between ejection ports, which are separated from each other by a degree by which no electric field interference will occur, and the shield electrode is provided only between ejection ports that are close to each other.

Even in this case, it is sufficient that the shield electrode 20 is formed so that the inner edge portion of the shield electrode 20 is more apart from the ejection port 28 than the inner edge portion of the ejection electrode 18 of an own channel and is closer to the ejection port 28 than the outer edge portion of the ejection electrode 18.

The shape of the opening 36 of the shield electrode 20 is set approximately the same as the shape of the ejection port 28, however, the present invention is not limited to this and the opening 36 of the shield electrode 20 may have another arbitrary shape so long as it is possible to prevent electric field interference by shielding against electric lines of force between adjacent ejection electrodes 18. For instance, it is possible to form the opening 36 in a circular shape, an oval shape, a square shape, or a rhomboid shape.

As explained in detail above, the ink jet head 10 is basically constructed in the above described manner.

As shown in FIG. 1A, the ink jet recording apparatus using the ink jet head 10 is constructed such that the counter electrode 24 is arranged to face the surface of the ink jet head 10 from which the ink droplets R are ejected.

The counter electrode 24 is arranged at a position facing the tip end portions 14a of the ink guides 14, and includes an electrode substrate 24a which is grounded and an insulating sheet 24b arranged on the lower surface of the electrode substrate 24a in FIG. 1A, i.e., on the surface of the electrode substrate 24a on the ink jet head 10 side.

The recording medium P is held on the lower surface of the counter electrode 24 in FIG. 1A, that is, on the surface of the insulating sheet 24b by electrostatic attraction for example. The counter electrode 24 (insulating sheet 24b) functions as a platen for the recording medium P.

At least during recording, the recording medium P held on the insulating sheet 24b of the counter electrode 24 is charged by the charging unit 26 to a predetermined negative high voltage opposite in polarity to that of the drive voltage applied to the ejection electrode 18.

Consequently, the recording medium P is charged negative to be biased to the negative high voltage to function as the substantial counter electrode to the ejection electrode 18, and is electrostatically attracted to the insulating sheet 24b of the counter electrode 24.

The charging unit 26 includes a scorotron charger 26a for charging the recording medium P to a negative high voltage, a high voltage power source 26b for supplying a negative high voltage to the scorotron charger 26a, and a bias voltage source 26c. Note that the corona wire of the scorotron charger 26a is connected to the terminal of the high voltage power source 26b on the negative side, and the terminal of the high voltage power source 26b on the positive side and the metallic shield case of the scorotron charger 26a are grounded. The terminal of the bias voltage source 26c on the negative side is connected to the grid electrode of the scorotron charger 26a, and the terminal of the bias voltage source 26c on the positive side is grounded.

The charging means of the charging unit 26 used in the present invention is not limited to the scorotron charger 26a, and hence various discharge means such as a corotron charger, a solid-state charger and an electrostatic discharge needle can be used.

In addition, in the illustrated example, the counter electrode 24 includes the electrode substrate 24a and the insulating sheet 24b, and the charging unit 26 is used to charge the recording medium P to a negative high voltage to apply a bias voltage to the medium P so that the medium P functions as the counter electrode and is electrostatically attracted to the surface of the insulating sheet 24b. However, this is not the sole case of the present invention and another configuration is also possible in which the counter electrode 24 is constituted only by the electrode substrate 24a, and the counter electrode 24 (electrode substrate 24a itself) is connected to a bias voltage power source for supplying a negative high voltage and is always biased to the negative high voltage so that the recording medium P is electrostatically attracted to the surface of the counter electrode 24.

Further, the electrostatic attraction of the recording medium P to the counter electrode 24, and the charge of the recording medium P to the negative high voltage or the application of the negative high bias voltage to the counter electrode 24 may be performed using separate negative high voltage sources. Also, the holding of the recording medium P by the counter electrode 24 is not limited to the utilization of the electrostatic attraction of the recording medium P, and hence any other holding method or holding means may be used for holding the recording medium P by the counter electrode 24.

Examples of the holding means of the recording medium P include means that applies a mechanical method such as fixing means of holding the forward and rear ends of the recording medium P, a pressing roller or the like, and means that applies a method in which suction holes communicating with a suction unit are formed in the surface of the counter electrode 24 facing the ink jet head 10 and the recording medium is fixed on the counter electrode by the suction force from the suction holes.

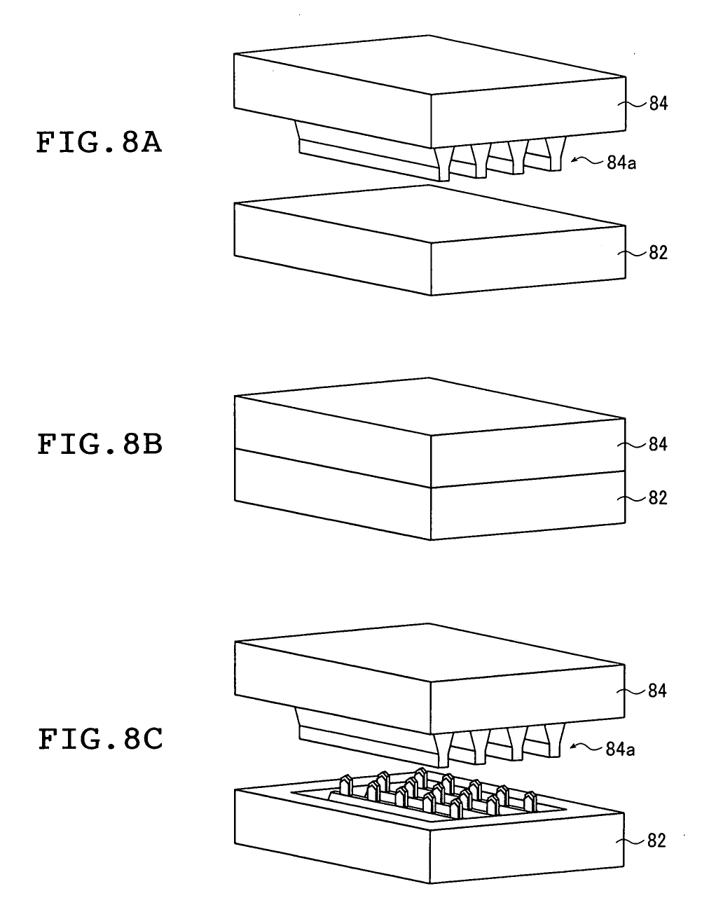

Next, a description will be made of the method of manufacturing the ink jet head having the structure as shown in FIG. 1A and FIG. 1B with reference to the drawings (FIGS. 8A to 8C).

In the method of manufacturing the ink jet head 10, the head substrate 12 including the ink guides 14 is manufactured by the method of manufacturing a resin molded article according to the present invention. Then, the ejection port substrate 16 is manufactured by the semiconductor process. The head substrate 12 is mounted on the ejection port substrate 16 so that center axes of the ink guides 14 of the head substrate 12 can substantially coincide with centers of the ejection ports 28 of the ejection port substrate 16, and the ink jet head is thereby manufactured.

First, a description will be made of an example of manufacturing the head substrate 12 having the structure shown in FIG. 3 and FIGS. 4A to 4C by the method of manufacturing a resin molded article according to the present invention. The head substrate 12 is manufactured by using the nanoimprint method. Specifically, a die (e.g., metal die) having a minute irregular (concave and convex) pattern corresponding to the ink guides 14 of the head substrate 12 is pressed against a heated substrate as a molding target, whereby the irregular pattern is transferred to the resin substrate as the molding target. Then, the resin substrate is released from the die (e.g., metal die). In such a way, the head substrate is manufactured. The present invention is not limited to using a die made of metal, i.e., metal die, as the die, and it is possible to use other dies such as a die made of glass (i.e., glass die), a die made of resin (i.e., resin die), a sintered die, and a die made of ceramics (i.e., ceramic die). In the following explanation, a metal die is used as a representative example.

In this embodiment, there is detected at least one of a temperature of the metal die, a temperature of the resin substrate, and resistance force received by the metal die from such a resin material when the metal die is pressed against the resin material by a predetermined amount. The metal die is pressed against the resin material while correcting press conditions based on the detected value. Specifically, the metal die is pressed against the resin substrate gradually in plural stages while controlling the temperature of the resin substrate and the temperature of the metal die. Further, when the metal die is pressed against the resin substrate in stages of a given amount, the temperature of the resin substrate, the temperature of the metal die, and the press resistance are detected for each step. Then, while correcting the press conditions (e.g., the temperature of the resin substrate, the temperature of the metal die, a press speed, and a press load) based on the detected values, the pressing of the next stage is sequentially performed under the corrected press conditions. In such a way, the irregular pattern formed on the metal die is transferred to the resin substrate, and the head substrate including the plurality of minute ink guides is formed in a lump.

A description will be made below in detail of the above.

First, as shown in FIG. 8A, a flat resin substrate 82 as the molding target and a metal die 84 are prepared. As a material of the resin substrate 82, there can be used thermoplastic resin that is an amorphous material, for example, polymethyl methacrylate (PMMA), polycarbonate (PC), and cycloolefin polymer (COP). Polymethyl methacrylate (PMMA) and polycarbonate (PC) are preferable because of ink resistance inherent therein. Dimensions of the resin substrate 82 can be changed as appropriate in accordance with dimensions of the ink jet head to be manufactured.

Such a resin substrate 82 as the molding target is uniformly heated up to the glass transition point or more. A heating method of the resin substrate 82 is not particularly limited. For example, there can be exemplified: a method of heating the resin substrate 82 as the molding target mounted on a support stage for supporting the resin substrate 82 in such a manner that a heater is provided to the support stage, and the support stage is heated; and a method of heating the resin substrate 82 mounted on the support stage in such a manner that a temperature regulation flow path for passing a temperature regulation medium such as water and oil therethrough is formed inside the support stage, and the temperature regulation medium heated up to a predetermined temperature is circulated through the temperature regulation flow path. Further, those methods can be used in combination.

The metal die 84 is a metal die made, for example, of metal such as NAK, HPM, SKD-61, ATAVAX, PDS, SCM, and S55C. On the metal die 84, an irregular pattern 84a corresponding to the ink guides 14 and opening portions 42 of the head substrate 12 shown in FIG. 3 and FIGS. 4A to 4C is formed. The irregular pattern 84a can be formed, for example, by laser processing, cutting processing, discharge processing, and electron beam processing.

Similarly to the resin substrate 82, the metal die 84 having such a structure is disposed while being heated up to the glass transition point or more of the resin substrate 82 for use so that a surface of the metal die 84, on which the irregular pattern 84a is formed, can face a surface of the resin substrate 82. In this case, a heating method of the metal die 84 is not particularly limited, either. There can be exemplified: a method of heating the metal die 84 in such a manner that a heater is provided to a metal die holding member for holding the metal die 84, and the metal die holding member is heated up; and a method of heating the metal die holding member or the metal die 84 in such a manner that a temperature regulation flow path for passing the temperature regulation medium such as water and oil therethrough is formed inside the metal die holding member or the metal die 84, and the temperature regulation medium heated up to a predetermined temperature is circulated through the temperature regulation flow path. Those methods can be used in combination.

Next, as shown in FIG. 8B, the surface of the metal die 84, on which the irregular pattern is formed, is pressed against the resin substrate 82 in stages with a predetermined pressure while being maintained parallel to the surface of the resin substrate 82. Specifically, the metal die 84 is pressed into the resin substrate 82 with the predetermined pressure in stages of a given depth (e.g., approximately 1 μm).

In this embodiment, when the metal die 84 is pressed against the resin substrate 82 by a given depth under predetermined press conditions (e.g., press speed, press load, temperature of the resin, and temperature of the metal die), force (hereinafter, referred to as press resistance) received by the metal die 84 from the resin substrate 82, the temperature of the resin substrate 82, and the temperature of the metal die 84 are individually detected. Then, based on the detected values, the press conditions for the next pressing of the metal die 84 into the resin substrate 82 by the predetermined amount are controlled. Specifically, the presswork is performed while the press conditions are being self-corrected based on the press resistance, the temperature of the resin substrate, and the temperature of the metal die.

In this case, the temperature of the resin substrate 82 may be detected, for example, in such a manner that a temperature of the surface of the resin substrate 82 is measured by using a temperature sensor, or alternatively, that a temperature of a heating unit of a heating device for heating the resin substrate 82 is regarded as the temperature of the resin substrate 82, and the temperature of the heating unit is measured.

Further, the temperature of the metal die 84 may be detected in such a manner that a temperature sensor is installed on the surface of the metal die 84, and the temperature of the surface of the metal die 84 is measured by means of the temperature sensor, or alternatively, that a temperature of a heating unit of a heating device for heating the metal die 84 is regarded as the temperature of the metal die 84, and the temperature of the heating unit of the heating device is measured by means of the temperature sensor.

Further, the press resistance can be detected, for example, in such a manner that a pressure sensor such as a piezoelectric element or the like is mounted onto a metal die support member for supporting the metal die.

As described above, in this embodiment, the metal die 84 is pressed into the resin substrate 82 in stages or continuously while controlling the temperature of the resin, the temperature of the metal die, the press speed, and the press load. Accordingly, even if the concave portions of the metal die 84 are minute, the resin can be filled into the concave portions positively and sufficiently, and the ink guides with an aspect ratio of 5 or more can be easily formed on the body of the head substrate.

In this case, while controlling all of the temperature of the resin, the temperature of the metal die, the press speed, and the press load, the metal die 84 is pressed against the resin substrate 82, and the irregular pattern of the metal die 84 is transferred to the surface of the resin substrate 82. However, in the present invention, the metal die may be pressed against the resin substrate while controlling at least one of the above-mentioned factors.

As described above, the metal die 84 is pressed into the resin substrate 82 in stages of a predetermined amount, and the irregular pattern 84a formed on the metal die 84 is transferred to the resin substrate 82. Thereafter, the metal die 84 and the resin substrate 82 are cooled to a temperature lower than the glass transition point to cure the resin substrate 82. With regard to a method of cooling the resin substrate 82, for example, in the case of heating the resin substrate 82 by the heater provided to the support stage, the resin substrate 82 may be naturally cooled only by stopping the heating by the heater, or the resin substrate 82 may be forcibly cooled by further air-cooling or water-cooling the support stage. Further, in the case of heating the resin substrate in such a manner that the temperature regulation medium heated up to the predetermined temperature is circulated through the temperature regulation flow path formed in the support stage for supporting the resin substrate 82, the resin substrate 82 may be cooled by circulating, through the temperature regulation flow path, the temperature regulation medium cooled to a predetermined temperature.

Further, with regard to a method of cooling the metal die 84, for example, in the case of heating the metal die 84 by the heater provided to the metal die holding member for holding the metal die 84, the metal die 84 may be naturally cooled by stopping the heating by the heater, or the metal die 84 may be forcibly cooled by air-cooling or water-cooling the metal die or the metal die holding member. Further, in the case of heating the metal die 84 in such a manner that the temperature regulation medium heated up to the predetermined temperature through the temperature regulation flow path formed in the metal die or the metal die holding member, the metal die 84 may be cooled by circulating, through the temperature regulation flow path, the temperature regulation medium cooled to a predetermined temperature.

After the resin substrate 82 and the metal die 84 are cooled to cure the resin substrate 82, as shown in FIG. 8C, the metal die is released from the metal die so that the irregular pattern transferred to the resin substrate cannot be broken. Thus, as shown in FIG. 3 and FIGS. 4A to 4C, the head substrate, in which the minute ink guides are arranged at equal intervals, may be manufactured with high precision.

In this embodiment, as described above, the irregular pattern of the metal die is transferred to the resin substrate by using the nanoimprint method while controlling the press conditions, thus making it possible to manufacture the head substrate including the minute ink guides.

The description has been made above of the method of manufacturing a resin molded article according to the present invention by taking as an example the method of manufacturing the head substrate including the minute ink guides. However, the method of manufacturing a resin molded article according to the present invention is not limited only to the method of manufacturing the head substrate including the ink guides as described above, and can be applied to methods of manufacturing various resin molded articles having a structure in which a plurality of minute concave portions or convex portions are formed. For example, in a molecular diagnosis as described in JP 11-187900 A and JP 11-510681 A, the method of manufacturing a resin molded article according to the present invention can also be applied to a method of manufacturing a substrate of a DNA chip in which known DNA molecules are arranged on minute convex portions regularly with high density.

Next, a description will be made of a method of manufacturing the ejection port substrate 16 having the structure shown in FIG. 1A and FIG. 1B.

As shown in FIG. 1A and FIG. 1B, the ejection port substrate 16 is an insulating substrate formed of an insulating material in which a large number of the ejection ports for ejecting the ink are formed. On one of the surfaces of the ejection port substrate 16, the shield electrode 20 is formed, and the ejection electrodes 18 are formed on the peripheries of the ejection ports on the other surface thereof.

First, a flat insulating substrate is prepared. This insulating substrate just needs to be a substrate formed of an insulating material. As the insulating material, for example, glass, ceramic materials such as Al₂O₃ and ZrO₂, and resins can be illustrated.

Subsequently, the shield electrode and the ejection electrodes are formed on an upper surface and lower surface of the insulating substrate by a semiconductor manufacturing process.

First, a metal layer for the shield electrode is formed on the upper surface of the insulating substrate. As a method of forming the metal layer, for example, there are given known film formation methods including a method of pasting thin metal foil by an adhesive, and a vapor deposition method such as a chemical vapor deposition (CVD) and a sputtering method.

For the metal layer, for example, a material such as copper, silver, and gold can be used.

Subsequently, on the metal layer on the upper surface of the insulating substrate, a mask having a pattern corresponding to the shield electrode is formed by a photolithography technology. Then, an etching is performed through the mask, and the metal layer formed on the upper surface of the insulating substrate is partially removed. Then, the mask is removed after the etching, and the shield electrode is thereby formed on the upper surface of the insulating substrate.

Next, an insulating layer is formed on the surface of the insulating substrate on which the shield electrode is formed. As a method of forming the insulating layer, for example, coating using a spinner, screen printing, and the like can be used. Moreover, as materials of the insulating layer, for example, polyimide, epoxy, fluorocarbon resin, phenolic resin, and the like can be used. Polyimide is preferable because of excellent insulating property and heat resistance thereof. It is preferable that a film thickness of the insulating layer be 10 to 100 μm because the ejection port substrate 16 should be thinned while maintaining the insulating property thereof.

Next, on the opposite surface (i.e., lower surface) of the insulating substrate, a metal layer for the ejection electrodes is formed. A material and forming method of the metal layer may be similar to those of the shield electrode, or may be different therefrom. Further, it is preferable that a film thickness of the metal layer be 3 to 50 μm because the ejection port substrate 16 should be thinned while maintaining etching resistance thereof.

Subsequently, on the metal layer, a mask having a pattern corresponding to the ejection electrodes is formed by the photolithography technology. Then, etching is performed through the mask to partially remove the metal layer, and thereafter, the mask is removed. Thus, the ejection electrodes are formed on the lower surface of the insulating substrate.

In this embodiment, the ejection electrodes are formed after forming the shield electrode; however, a forming order of the shield electrode and the ejection electrodes is not particularly limited, and the ejection electrodes may be formed first. Further, though the metal layers are formed on the upper and lower surfaces of the insulating substrate in different steps, the metal layers may be formed on the upper and lower surfaces of the insulating substrate continuously or simultaneously. Meanwhile, similarly to the above, the shield electrode and the ejection electrodes can be formed on the upper and lower surfaces of the insulating substrate by using the semiconductor manufacturing process.

Through holes serving as the ejection ports are formed in the insulating substrate on which the shield electrode, the insulating layer, and the ejection electrodes are formed in the above-mentioned manner. In order to form the through holes, laser, a drill, or a sandblasting device can be used.

In the case of forming the through holes in the insulating substrate by means of the sandblasting device, a method can be applied, in which such a metal mask layer as covering regions other than regions equivalent to the through holes is formed, and an abrasive is jetted by the sandblasting device through the metal layer. For the abrasive, for example, alumina, silicon carbide, and the like can be used. It is suitable that a grain size of the abrasive be 5 to 60 μm. In order to change the shapes and dimensions of the through holes, the shapes and dimensions of the metal mask layer just need to be changed.

As the metal to be used for the metal mask layer, relatively hard metal such as stainless steel, Ni, and Cr is preferable in terms of durability. The semiconductor manufacturing process can be used as the method of forming the metal mask layer. In the case of thickening the metal mask layer in order to enhance the durability, after a thin metal mask layer is formed, the film thickness of the metal mask layer just needs to be thickened by an electrolytic plating method. After the through holes are formed in the insulating substrate, the metal mask layer is removed by an alkaline or acidic removal liquid.

In such a way described above, the ejection port substrate 16 having the structure shown in FIGS. 1A and 1B can be manufactured.

The head substrate 12 and the ejection port substrate 16, which are manufactured as described above, are arranged to face each other so that the ink guides of the head substrate 12 can be inserted into the ejection ports formed in the ejection port substrate 16. Thus, the ink jet head 10 having the structure shown in FIGS. 1A and 1B is manufactured.

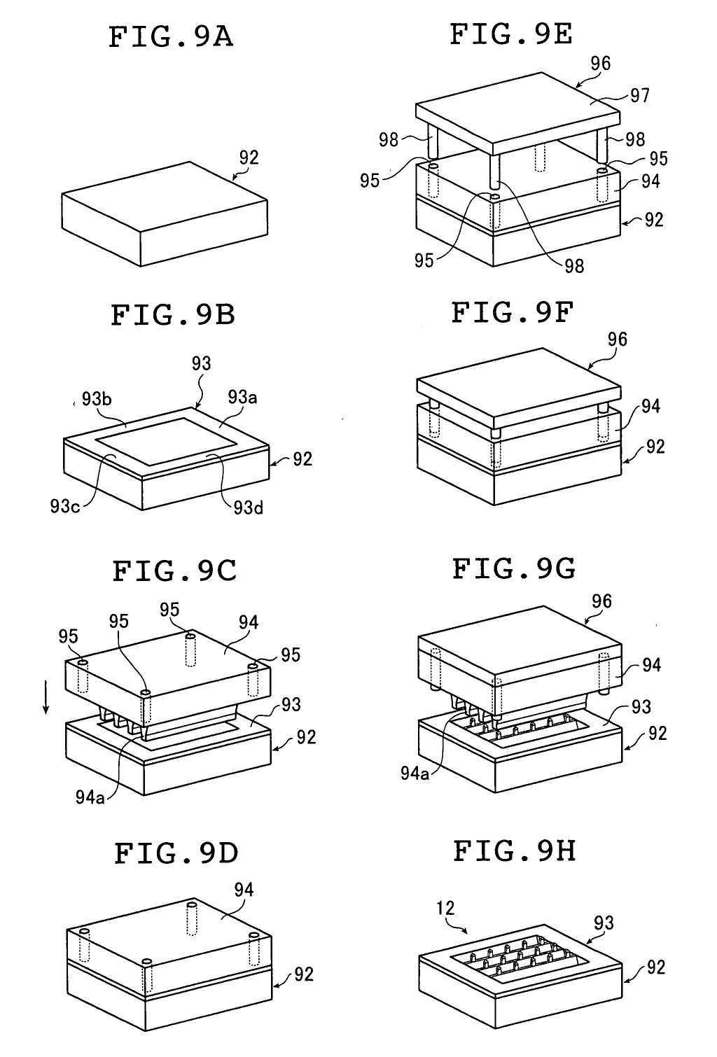

Next, as another example of the method of manufacturing the ink jet head 10 having the structure shown in FIGS. 1A and 1B, a description will be made, by using the drawings (FIGS. 9A to 11), of another embodiment of manufacturing the head substrate 12 having the structure shown in FIG. 3 and FIGS. 4A to 4C by the method of manufacturing a resin molded article according to the present invention. In the embodiment shown in FIGS. 9A to 11, it is possible to use various kinds of dies such as a die made of metal (i.e., metal die), a die made of glass (i.e., glass die), a die made of resin (i.e., resin die), a sintered die, and a die made of ceramics (i.e., ceramic die). In the following explanation, a metal die is used as a representative example.

First, as shown in FIG. 9A, a flat planar resin plate 92 as the molding target and a metal die 94 are prepared. As a material of the resin substrate 92, there can be used a thermoplastic resin that is an amorphous material, for example, polymethyl methacrylate (PMMA), polycarbonate (PC), and cycloolefin polymer (COP). Polymethyl methacrylate (PMMA) and polycarbonate (PC) are preferable because of ink resistance inherent therein. Dimensions of the resin substrate 92 can be changed as appropriate in accordance with dimensions of the ink jet head to be manufactured.

Next, as shown in FIG. 9B, a release plate 93 is mounted on a surface of the resin substrate 92. The release plate 93 is a rectangular frame body including broad and flat frame portions 93a, 93b, 93c and 93d arranged along four sides of the surface of the resin plate 92. In other words, the release plate 93 is a plate-like member having approximately the same size as the surface of the resin substrate 92 and a structure in which a rectangular opening is formed in the center. The release plate 93 is disposed so as to cover a region other than a region to which an irregular pattern of the metal die 94 is transferred.

The release plate 93 can be formed of various materials as long as the material has heat resistance and hardness enough not to be deformed by external force. For example, the release plate 93 can be formed of a material such as metal (e.g., SUS) and ceramics.

Next, the resin substrate 92 is uniformly heated up to the glass transition point or more. A heating method of the resin substrate 92 is not particularly limited. For example, there can be exemplified: a method of heating the resin substrate 92 as the molding target mounted on a support stage for supporting the resin substrate 92 in such a manner that a heater is provided to the support stage, and the support stage is heated; and a method of heating the resin substrate 92 mounted on the support stage in such a manner that a temperature regulation flow path for passing a temperature regulation medium such as water and oil therethrough is formed inside the support stage, and the temperature regulation medium heated up to a predetermined temperature is circulated through the temperature regulation flow path. Further, those methods can be used in combination.

Subsequently, the metal die 94 for forming a minute irregular pattern on the resin substrate 92 is prepared. The metal die 94 is a metal die made, for example, of metal such as NAK, HPM, SKD-61, ATAVAX, PDS, SCM, and S55C. On the metal die 94, an irregular pattern 94a corresponding to the ink guides 14 and opening portions 42 of the head substrate shown in FIG. 3 and FIGS. 4A to 4C is formed. The irregular pattern 94a can be formed, for example, by laser processing, cutting processing, discharge processing, and electron beam processing.

The metal die 94 is disposed so as to face the resin substrate 92 so that its formed surface of the irregular pattern can be parallel to the surface of the resin substrate 92. As will be described later, the metal die 94 can move in a direction perpendicular to the surface of the resin substrate 92, and can press the resin substrate 92 with a predetermined pressure. For example, hydraulic and pneumatic press mechanisms can be used as means for pressing the metal 94 against the resin substrate 92.

Further, in the vicinities of four corners of the metal die 94, columnar through holes 95 passing through the metal die 94 in a thickness direction are individually formed.

Similarly to the resin substrate 92, the metal die 94 having such a structure is disposed while being heated up to the glass transition point or more of the resin substrate 92 for use so that a surface of the metal die 94, on which the irregular pattern 94a is formed, can face a surface of the resin substrate 92. In this case, a heating method of the metal die 94 is not particularly limited, either. There can be exemplified: a method of heating the metal die 92 in such a manner that a heater is provided to a metal die holding member for holding the metal die 94, and the metal die holding member is heated up by the heater; and a method of heating the metal die holding member or the metal die in such a manner that a temperature regulation flow path for passing the temperature regulation medium such as water and oil therethrough is formed inside the metal die holding member or the metal die 94, and the temperature regulation medium heated up to a predetermined temperature is circulated through the temperature regulation flow path, and the like. Those methods can be used in combination.

Next, as shown in FIG. 9C, the surface of the metal die 94, on which the irregular pattern is formed, is pressed against the resin substrate 92 in stages or continuously with a predetermined pressure while being maintained parallel to the surface of the resin substrate. When the metal die 94 is pressed against the resin substrate 92 in stages, the metal die 94 just needs to be pressed into the resin substrate 92 with the predetermined pressure in stages of a given depth (e.g., approximately 1 μm).

In this case, when the metal die 94 is pressed against the resin substrate 92, the portion of the metal die 94, on which the irregular pattern is formed, passes through the opening portion of the release plate 93, and is pressed against the resin substrate 92. Then, the above-mentioned portion is buried inside the resin substrate 92, and the resin is gradually filled into the concave portions of the irregular pattern of the metal die 94. When the metal die 94 is further pressed into the resin substrate 92 intermittently, the circumferential portion of the metal die 94, on which the irregular pattern is not formed, faces and intimately contacts surfaces of the frame portions of the release plate 93 (refer to FIG. 9D). Specifically, the release plate 93 is sandwiched between the metal die 94 and the resin substrate 92.

The through holes 95 in the vicinities of the four corners of the metal die 94 face the release plate 93. Accordingly, even if the metal die 94 is pressed against and brought into intimate contact with the resin substrate 92, the inside of the through holes 95 is not filled with the heated resin. As described above, the release plate 93 has a function to prevent the heated resin from being filled into the through holes 95 of the metal die 94.

Also in this embodiment, when the metal die 94 is pressed against the resin substrate 92 under predetermined conditions (e.g., press speed, press load, temperature of the resin, and temperature of the metal die), it is preferable to individually detect force (hereinafter, referred to as press resistance) received by the metal die 94 from the resin substrate 92, a temperature of the resin substrate 92, and a temperature of the metal die 94. For example, in the case where the metal die 94 is pressed against the resin substrate 92 in stages, preferably, when the metal die 94 is pressed against the resin substrate 92 by a given depth, the press resistance, the temperature of the resin substrate 92, and the temperature of the metal die 94 are individually detected, and the presswork is performed while self-correcting the press conditions for the next pressing of the metal die 94 into the resin substrate 92 by the predetermined amount based on the above detected values. Further, when the metal die 94 is continuously pressed against the resin substrate 92, preferably, the press resistance, the temperature of the resin substrate 92, and the temperature of the metal die 94 are individually detected for each given time, and the presswork is performed while self-correcting the press conditions based on the detected values.

In the present invention, it is preferable to perform the presswork while self-correcting the press conditions based on the press resistance, the temperature of the resin substrate, and the temperature of the metal die as described above. In such a way, the head substrate including the minute ink guides with an aspect ratio of 5 or more can be manufactured.

In this case, the temperature of the resin substrate 92 may be detected, for example, in such a manner that a temperature of the surface of the resin substrate 92 is measured by using a temperature sensor, or alternatively, that a temperature of a heating unit of a heating device for heating the resin substrate 92 is regarded as the temperature of the resin substrate 92, and the temperature of the heating unit is measured.

Further, the temperature of the metal die 94 may be detected in such a manner that a temperature sensor is mounted onto the surface of the metal die 94, and the temperature of the surface of the metal die 94 is measured by means of the temperature sensor, or alternatively, that a temperature of a heating unit of a heating device for heating the metal die 94 is regarded as the temperature of the metal die 94, and the temperature of the heating unit of the heating device is measured by means of the temperature sensor.

Further, the press resistance can be detected, for example, in such a manner that a pressure sensor such as a piezoelectric element or the like is mounted onto a metal die support member for supporting the metal die.

As described above, in this embodiment, the metal die 94 is pressed into the resin substrate 92 in stages or continuously while controlling the temperature of the resin, the temperature of the metal die, the press speed, and the press load. Accordingly, even if the concave portions of the metal die 94 are minute, the resin can be filled into the concave portions positively and sufficiently, and the ink guides with an aspect ratio of 5 or more can be easily formed on the body of the head substrate.

In this case, while controlling all of the temperature of the resin, the temperature of the metal die, the press speed, and the press load, the metal die 94 is pressed against the resin substrate 92, and the irregular pattern of the metal die 94 is transferred to the surface of the resin substrate 92. However, in the present invention, the metal die may be pressed against the resin substrate while controlling at least one of the above-mentioned factors.

As described above, the metal die 94 is pressed into the resin substrate 92 in stages of the predetermined amount, and the irregular pattern 94a formed on the metal die 94 is transferred to the resin substrate 92. Thereafter, the metal die 94 and the resin substrate 92 are cooled to a temperature lower than the glass transition point to cure the resin substrate 92. With regard to a method of cooling the resin substrate 92, for example, in the case of heating the resin substrate 92 by the heater provided to the support stage, the resin substrate 92 may be naturally cooled only by stopping the heating by the heater, or the resin substrate 92 may be forcibly cooled by further air-cooling or water-cooling the support stage. Further, in the case of heating the resin substrate in such a manner that the temperature regulation medium heated up to the predetermined temperature is circulated through the temperature regulation flow path formed in the support stage for supporting the resin substrate 92, the resin substrate 92 may be cooled by circulating, through the temperature regulation flow path, the temperature regulation medium cooled to a predetermined temperature.

Further, with regard to a method of cooling the metal die 94, for example, in the case of heating the metal die 94 by the heater provided to the metal die holding member for holding the metal die 94, the metal die 94 may be naturally cooled by stopping the heating by the heater, or the metal die 94 may be forcibly cooled by air-cooling or water-cooling the metal die or the metal die holding member. Further, in the case of heating the metal die 94 in such a manner that the temperature regulation medium heated up to the predetermined temperature through the temperature regulation flow path formed in the metal die or the metal die holding member, the metal die 94 may be cooled by circulating, through the temperature regulation flow path, the temperature regulation medium cooled to a predetermined temperature.

After the resin substrate 92 and the metal die 94 are cooled to cure the resin substrate 92, the resin substrate 92 is released from the metal die 94 by using a release jig 96 shown in FIG. 9E so that the irregular pattern transferred to the resin substrate 92 cannot be broken.

As shown in FIG. 9E, the release jig 96 includes a planar body portion 97, and four leg portions 98 formed at positions slightly toward the center from four corners of the body portion 97. The body portion 97 and the leg portions 98 can be formed of various materials as long as the material has hardness enough not to be deformed by external force. For example, the body portion 97 and the leg portions 98 can be formed of materials such as a metal (e.g., SUS, NAK, HPM, SKD-61, ATAVAX, PDS, SCM, and S55C), ceramics, and the like. The thickness of the body portion 97 is thinner than that of the metal die 94, and a length and width of the body portion 97 are approximately the same as those of the metal die 94; however, dimensions of the body portion 97 of the release jig 96 are not limited to these.

The leg portions 98 of the release jig 96 are provided perpendicularly to a surface of the body portion 97 so as to be individually insertable into the through holes 95 formed in the vicinities of the four corners of the metal die 94. All of the leg portions 98 have a columnar shape, and are formed to have mutually the same length, and to be longer than the thickness of the metal die 94. Since it is necessary for the leg portions 98 to be inserted into the through holes 95 of the metal die 94, the leg portions 98 are formed with a diameter somewhat smaller than the inner diameter of the through holes 95 of the metal die 94. The leg portions 98 of the release jig 96 serve as pressing portions for pressing the release plate 93 when the resin substrate 92 is released.

When the resin substrate 92 is released, the metal die 94 in intimate contact with the resin substrate 92 is fixed by a fixing member (not shown). Then, as shown in FIG. 9F, the leg portions 98 of the release jig 96 are inserted into the through holes 95 open to the surface of the metal die 94, which is opposite to the surface where the irregularities are formed, and the release jig 96 is made to approach the metal die 94. The leg portions 98 reach the release plate 93 located between the metal die 94 and the resin substrate 92, and press the four corner portions of the release plate 93. As described above, the four corners of the release plate 93 are simultaneously pressed with uniform force by the four leg portions 98 of the release jig 96. As shown in FIG. 9G, when the release jig 96 is made to further approach the metal die 94 in a state where the metal die 94 is fixed, the resin substrate 92 is forced out of the metal die 94 through the release plate 93 by the pressing force of the leg portions 98 of the release jig 96. At this time, the resin substrate 92 is spaced and released from the metal die 94 while maintaining a parallel state to the surface of the metal die 94. In such a way, the head substrate 12 in which the ink guides are formed is manufactured (refer to FIG. 9H).

In this embodiment, as described above, the resin substrate 92 can be released by using the release plate 93 and the release jig 96 while maintaining the parallel state to the surface of the metal die 94. Therefore, the ink guides formed on the surface of the resin substrate 92 substantially perpendicularly can be prevented from being deformed when the resin substrate 92 is released.

Further, after the resin substrate 92 is released, the release plate 93 disposed in intimate contact with the surface of the resin substrate 92 may be removed from the resin substrate 92. Alternatively, the release plate 93 may be left on the surface of the resin substrate 92, and may be used as a reinforcement member for preventing deformation of the head substrate.

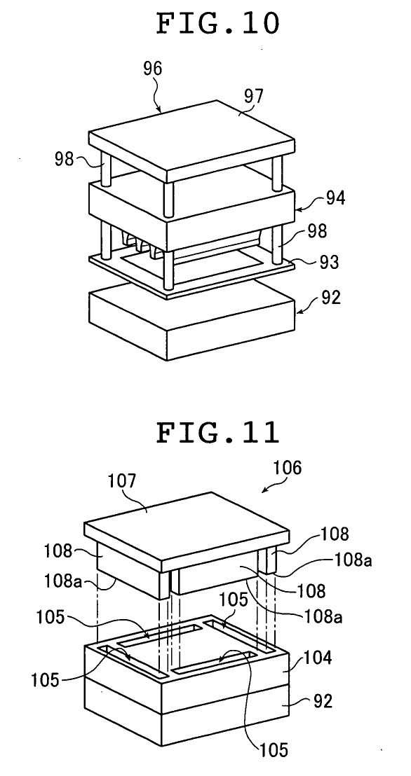

In the above-mentioned example, the release plate 93 as shown in FIG. 9B and the release jig 96 as shown in FIG. 9E are used, the release plate 93 is pressed by the stick-like leg portions 98 of the release jig 96, and the resin substrate 92 is released. However, in the present invention, the method of releasing the resin substrate is not limited to this method. For example, instead of constructing the release plate 93 and the leg portions 98 of the release jig 96 by separate parts, as shown in FIG. 10, the release plate 93 may be fixed and integrated with the leg portions 98 of the release jig 96. In this case, the leg portions 98 of the release jig 96 are constructed so as to be detachable from the body portion 97, and as shown in FIG. 10, there can be employed a method of fixing the leg portions 98 to the body portion 97 after inserting the leg portions 98 of the release jig 96 into the through holes 95 of the metal die 94. Then, at the time of the presswork, the metal die 94 is pressed against the resin substrate 92 together with the release plate 93 while keeping the release plate 93 in intimate contact with the metal die 94. In this case, the presswork is performed while the metal die 94 is being supported from the side surfaces thereof and the like by the release jig 96. Alternatively, in a state where only the release plate 93 is pressed against the surface of the resin substrate 92, the metal die 94 is pressed against the resin substrate 92 while being guided by the leg portions 98 of the release jig 96 which are inserted into the through holes 95. Then, after the resin substrate 92 is cooled and cured, the release jig 96 and the metal die 94 are moved relatively to each other so that the body portion 97 of the release jig 96 can approach the metal die 94, and in such a way, the resin substrate 92 is released from the metal die 94. As a method of making the body portion 97 of the release jig 96 approach the metal die 94, there can be applied a method of pressing the release plate 93 against the surface of the resin substrate 92 and moving the metal die 94 toward the body portion 97 of the release jig 96 while keeping on thrusting the resin substrate 92 against a support stage on which the resin substrate 92 is mounted, and a method of moving at least one of the metal die 94 and the body portion 97 of the release jig 96 in a direction where both of them approach each other without thrusting the resin substrate 92 against the support stage on which the resin substrate 92 is mounted.

The methods as described above also make it possible to release the resin substrate 92 from the metal die 94 without deforming the ink guides formed on the surface of the resin substrate 92 substantially perpendicularly when the resin substrate 92 is released.

In the above-mentioned example, as shown in FIGS. 9E to 9G, the release plate 93 is interposed between the metal die 94 and the resin substrate 92, the leg portions 98 of the release jig 96 are inserted from the through holes 95 formed in the metal die 94, then the release plate 93 is partially pushed by the leg portions 98, and the resin substrate 92 is thereby released. However, for example, the resin substrate 92 can also be released in such a manner that a release jig 106 with a shape shown in FIG. 11 is used, and the surface of the resin substrate 92 is directly pushed by leg portions 108 of the release jig 106.

The release jig 106 shown in FIG. 11 includes a rectangular plate-like body portion 107, and four planer leg portions 108 provided perpendicularly to a surface of the body portion 107. The respective leg portions 108 are provided to the inside of an outer circumference of the surface of the body portion 107 so as to be along the respective sides of the surface of the body portion 107. The four leg portions 108 are formed to have entirely the same length, and to be longer than the thickness of a metal die 104. Further, tip ends 108a of the leg portions 108 are formed to be flat.

Four through holes 105 with an elongated quadrangular shape, which penetrate the metal die 104 in the thickness direction thereof, are formed so as to be along four sides of the metal die 104. The through holes 105 are formed on the periphery of the irregular pattern of the metal die 104 so as to avoid a region of the metal die 104 where the irregular pattern is formed. The respective through holes 105 formed in the metal die 104 are provided in approximately the same dimensions as those of the respective leg portions 108 at positions corresponding to the respective leg portions 108 of the release. jig 106, so that the respective leg portions 108 of the release jig 106 can be inserted into the through holes 105 concerned when the resin substrate 92 is released.

In the case of using the release jig 106 as described above, in order to prevent the heated resin substrate 92 from entering the through holes of the metal die 104 at the time of the presswork, it is preferable that the leg portions 108 be inserted into the through holes 105 of the metal die 104 and fixed to the metal die 104 in advance so that surfaces of the tip ends 108a of the leg portions 108 of the release jig 106 can construct surfaces flush with the surface of the metal die 104. In this case, since the release jig 106 is present on the back surface of the metal die 104, the presswork is performed while supporting the metal die 104 from side surfaces thereof and the like by a support jig (not shown). Then, when the cured resin substrate 92 is released from the metal die 104, the release jig 106 is pressed into the metal die 104 more deeply, and by pressing force therefrom, the resin substrate 92 is forced out of the metal die 94. In such a way, the resin substrate 92 can be detached from the metal die 104 without deforming the resin substrate 92.

As described above, in the case where the surface of the resin substrate 92 is directly pushed by the leg portions 108 of the release jig 106 as shown in FIG. 11, it is preferable that a contact area between the tip ends 108a of the leg portions 108 of the release jig 106 and the resin substrate 92 be large. By making the contact area between the tip ends 108a of the leg portions 108 and the resin substrate 92 large as described above, when the surface of the resin substrate 92 is pushed by the leg portions 108, the leg portions 108 are prevented from being buried in the resin substrate 92. In addition, the region of the resin substrate 92 other than the region where the irregularities are formed can be pushed uniformly, and the deformation of the resin substrate 92 when the resin substrate 92 is released can be prevented.

Further, also in the case of using the release jig 106 shown in FIG. 11, the construction may be such that the release plate 93 as shown in FIG. 9B is interposed between the metal die 104 and the resin substrate 92, the release plate 93 is pressed by the leg portions 108 of the release jig 106, and the resin substrate 92 is released from the metal die 104.

Further, although the surface of the resin substrate is pressed by the four leg portions in the above-mentioned example, another aspect in which the surface of the resin substrate is pressed only by two leg portions opposite to each other may be adopted. The number of leg portions is not limited as long as the surface of the resin substrate or the surface of the release plate can be pushed uniformly.

As described above, in this embodiment, the irregular pattern of the metal die is transferred to the resin substrate by using the nanoimprint method while controlling the press conditions, whereby the head substrate including the minute ink guides can be manufactured. Moreover, the resin substrate can be taken out of the metal die by using the release plate and the release jig without deforming the minute ink guides.

Note that, since a method of manufacturing the ejection port substrate 16 in this embodiment is completely the same as that of the previously mentioned embodiment, a description thereof will be omitted.

The description has been made above in detail of the method of manufacturing a resin molded article according to the present invention by taking as an example the method of manufacturing the head substrate including the minute ink guides. However, the method of manufacturing a resin molded article according to the present invention is not limited only to the method of manufacturing the head substrate including the ink guides as described above, and can be applied to methods of manufacturing various resin molded articles having the structure in which the plurality of minute concave portions or convex portions are formed. For example, in the molecular diagnosis as described in JP 11-187900 A and JP 11-510681 A, the method of manufacturing a resin molded article according to the present invention can also be applied to a method of manufacturing a substrate of a DNA chip in which the known DNA molecules are arranged on the minute convex portions regularly with high density.

The description has been made above in detail of the method of manufacturing a resin molded article, the method of manufacturing an ink jet head utilizing the method of manufacturing a resin molded article, according to the present invention, and further, the ink jet head obtained by the method of manufacturing an ink jet head. However, the present invention is not limited to the above-mentioned embodiments, and it is a matter of course that various improvements and changes may be performed within the scope not departing from the gist of the present invention.

What is claimed is:

1. A method of manufacturing a resin molded article having a structure in which concave portions or convex portions are minutely formed, the method comprising:
a step of heating a resin material and a die having inverse shapes with respect to the shapes of the concave portions or the convex portions of the resin molded article;
a step of pressing the heated die against the heated resin material while correcting press conditions;
a step of detecting at least one of a temperature of the die, a temperature of the resin material, and resistance force received by the die from the resin material when the die is pressed against the resin material by a predetermined amount; and
a step of correcting the press conditions based on a value detected in the step of detecting.

2. The method of manufacturing the resin molded article according to claim 1, wherein the press conditions include at least one selected from the group consisting of a press speed, a press load, the temperature of the die and the temperature of the resin material.

3. The method of manufacturing the resin molded article according to claim 1, wherein a ratio H/W is 2 or more to 50 or less, where H is a height of the convex portions or a depth of the concave portions, and W is a length of short sides of the convex portions or the concave portions.

4. The method of manufacturing the resin molded article according to claim 1, wherein the resin material is amorphous thermoplastic resin.

5. The method of manufacturing the resin molded article according to claim 1, wherein the resin molded article is a constituent part of an ink jet head including an ejection port substrate in which ejection ports for ejecting ink are formed, and is a substrate disposed oppositely to the ejection port substrate and including slim planar ink guides for guiding the ink individually to the ejection ports.

6. A method of manufacturing an ink jet head, comprising:
a step of preparing, as constituent parts of the ink jet head that ejects ink as droplets, an ejection port substrate in which ejection ports for ejecting the ink are formed, and a head substrate disposed oppositely to the ejection port substrate and including slim planar ink guides for guiding the ink individually to the ejection ports; and
a step of disposing the ejection port substrate oppositely to the head substrate so that tip ends of the ink guides of the head substrate can be inserted into the ejection ports of the ejection port substrate,
wherein the step of preparing the head substrate comprises:
a step of heating a resin material and a die having inverse shapes with respect to the shapes of the ink guides of the head substrate;
a step of pressing the heated die against the heated resin material while correcting press conditions;
a step of detecting at least one of a temperature of the die, a temperature of the resin material, and resistance force received by the die from the resin material when the die is pressed against the resin material by a predetermined amount; and
a step of correcting the press conditions based on a value detected in the step of detecting.

7. A method of manufacturing a resin molded article having a structure in which concave portions or convex portions are minutely formed, the method comprising:
a step of heating a resin material and a die having inverse shapes with respect to the shapes of the concave portions or the convex portions of the resin molded article;
a step of pressing the heated die against the heated resin material;
a step of cooling and curing the resin material; and
a step of releasing the cured resin material from the die by directly or indirectly pressing, with a press member through a through hole formed in the die, a surface of the resin material on a side in intimate contact with the die and in a region other than a region in which the concave portions or convex portions are formed.

8. The method of manufacturing the resin molded article according to claim 7, wherein
the step of pressing includes a step of pressing the die against the resin material in a state where a release plate having a given thickness is interposed in the region of the surface of the resin material other than the region where the concave portions or convex portions are formed, and
the step of releasing is a step of releasing the resin material by pushing the release plate by the press member.

9. The method of manufacturing the resin molded article according to claim 8, wherein the release plate is fixed to the press member.

10. The method of manufacturing the resin molded article according to claim 7, further comprising:
a steps of detecting at least one of a temperature of the die, a temperature of the resin material, and resistance force received by the die from the resin material when the die is pressed against the resin material; and
a steps of correcting the press conditions based on a value detected in the step of detecting.

11. The method of manufacturing the resin molded article according to claim 10, wherein the press conditions include at least one selected from the group consisting of a press speed, a press load, the temperature of the die and the temperature of the resin material.

12. The method of manufacturing the resin molded article according to claim 7, wherein a ratio H/W is 2 or more to 50 or less, where H is a height of the convex portions or a depth of the concave portions, and W is a thickness of the convex portions or a length of the concave portions in a direction perpendicular to a longitudinal direction.

13. The method of manufacturing the resin molded article according to claim 7, wherein the resin material is amorphous thermoplastic resin.

14. The method of manufacturing the resin molded article according to claim 7, wherein the resin molded article is a constituent part of an ink jet head including an ejection port substrate in which ejection ports for ejecting ink are formed, and is a substrate disposed oppositely to the ejection port substrate and including slim planar ink guides for guiding the ink individually to the ejection ports.

15. A method of manufacturing an ink jet head, comprising:
a step of preparing, as constituent parts of the ink jet head that ejects ink as droplets, an ejection port substrate in which ejection ports for ejecting the ink are formed, and a head substrate disposed oppositely to the ejection port substrate and including slim planar ink guides for guiding the ink individually to the ejection ports; and
a step of disposing the ejection port substrate oppositely to the head substrate so that tip ends of the ink guides of the head substrate can be inserted into the ejection ports of the ejection port substrate,
wherein the step of preparing the head substrate comprises:
a step of heating a resin material and a die having inverse shapes with respect to the shapes of the ink guides of the head substrate;
a step of pressing the heated die against the heated resin material;
a step of cooling and curing the resin material; and
a step of releasing the cured resin material from the die by directly or indirectly pressing, with a press member through a through hole formed in the die, a surface of the resin material on a side in intimate contact with the die and in a region other than a region in which the ink guides of the head substrate are formed.
